(19) United States
(12) Patent Application Publication
(10) Pub. No.: US 2012/0048837 A1
(43) Pub. Date: Mar. 1, 2012

(54) LASER WELDING SYSTEM AND METHOD FOR WELDING BY MEANS OF A LASER BEAM

(75) Inventors: Martin Bleicher, Fichtenau (DE); Markus Haag, Duerrwangen (DE)

(73) Assignee: TYCO ELECTRONICS AMP GMBH, Bensheim (DE)

(21) Appl. No.: 13/318,692

(22) PCT Filed: Apr. 26, 2010
(86) PCT No.: PCT/EP2010/055533

§ 371 Date: Nov. 3, 2011

(30) Foreign Application Priority Data
May 7, 2009 (DE) 102009020272.2

(51) Int. Cl. B23K 26/00

(52) U.S. Cl. 219/121.64; 219/121.63

(57) ABSTRACT

The present invention relates to a laser welding system comprising a source (1) for a laser beam, a collimator (2) which is adapted to collimate the laser beam, and a focusing means (3) which is adapted to focus the collimated laser beam onto a concentrated point on a workpiece (4) to be welded. In order to allow for a homogeneous welding region, an optical element (5) is arranged between the collimator (2) and the focusing means (3), the optical element being adapted to spread a power distribution of the laser beam along a first direction running at an angle to an axis of the collimated laser beam. According to an alternative solution, the optical element (5) is arranged between the source (1) for the laser beam and the collimator (2).

The present invention relates to a laser welding system comprising a source for a laser beam, a collimator which is adapted to collimate the laser beam, and a focusing means which is adapted to focus the collimated laser beam onto a concentrated point on a workpiece to be welded. Furthermore, the present invention also relates to a corresponding method for welding by means of a laser beam.

The method for welding by means of a laser beam is a welding method used to join different workpieces together. The laser beam offers a concentrated heat source allowing thin and deep weld seams. The laser welding process is often used in applications associated with large quantities, such as for example in the automotive industry.

The laser beam which is used has a power density, typically in the range of approx. 1 MW/cm². Thus, small regions are influenced by the concentrated heat of the laser beam. The width of the laser beam varies between 0.2 mm and 13 mm, for example, although smaller widths are used in the welding process. The depth of penetration of the heat emitted by the laser beam is proportional to the amount of power supplied and is also dependent on the location of the focusing point. Maximum penetration is achieved when the focusing point is optimally set.

A continuous or pulsed laser beam can be used, based on the application. Millisecond-long pulses are used to weld thin materials, such as for example razor blades, to one another, whereas continuous laser systems are used for deep weld seams.

The laser welding method is a diverse process which is able to weld carbon steels, high-grade steel, aluminium, titanium and plastics, for example. The welding speed is proportional to the amount of power emitted, but is dependent on the type and the thickness of the workpieces. The high performance of gas lasers makes them particularly suitable for large-quantity applications.

In the known laser welding processes, plastic plates, films and injection-moulded parts are welded by sharply focused laser beams, a laser beam focused in a point-by-point manner being used to weld or fuse the plastics materials. The course of the weld seam is implemented by a programmable beam guide of the laser beams or the movement of the workpieces.

However, the distribution of the beam intensity is a drawback of a planar connection using a laser beam focused in a point-by-point manner, as the Gaussian distribution of the intensity causes a non-uniform fusion.

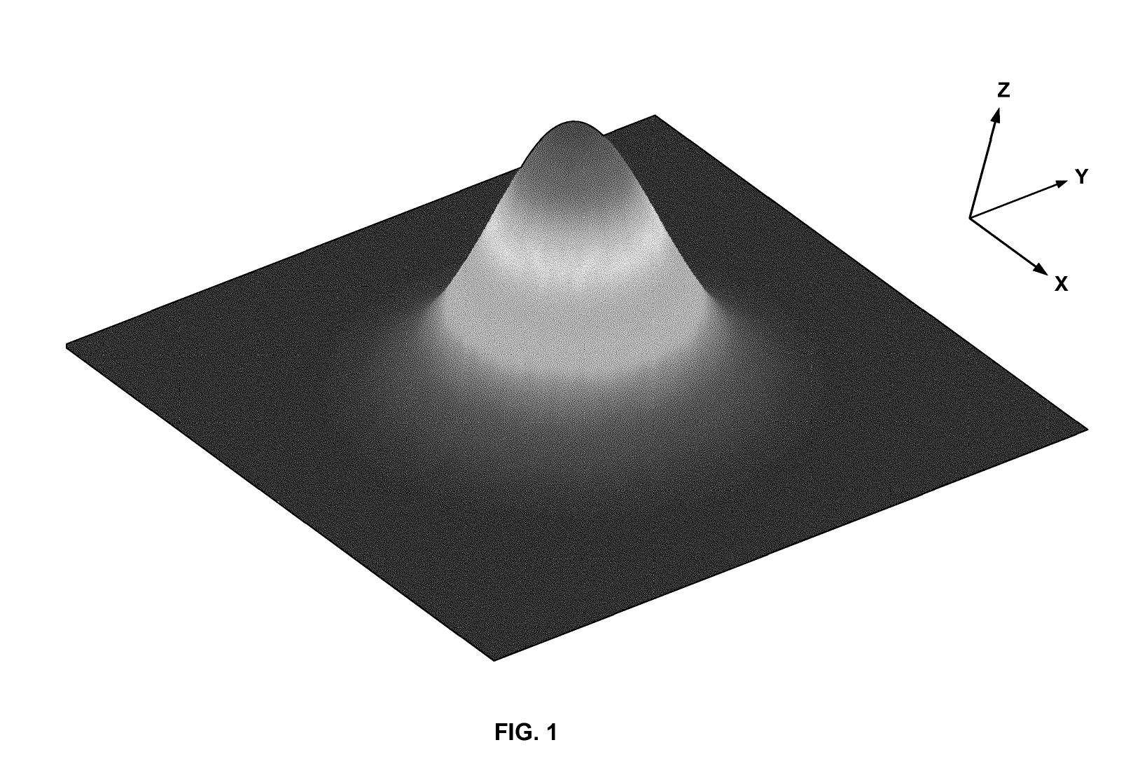

FIG. 1 shows a profile of a Gaussian power distribution of a laser beam generated by the processing optics of a laser welding system according to the prior art. In a power distribution of this type, the majority, approx. 90%, of the energy is present at the centre, what is known as the hot spot. A laser beam of this type allows exclusively point-by-point laser welding.

That is to say, only a fraction of the welding spot contributes to the strength and a laser welding process of this type is particularly prone to error, as the position of the welding spot has to be determined very precisely. In the case of a poor position of the welding spot, a disadvantageous energy input is obtained. In addition, there is the risk, if for example a spring steel has to be welded, that a poor position of the welding spot will lead to a burn-out of the welding spot on the spring steel.

The invention is based on the object of disclosing a laser welding system and a method for welding by means of a laser beam allowing a homogeneous welding region to be achieved.

This object is achieved by the subject matter of the independent claims. Preferred embodiments form the subject matter of the dependent claims.

According to one embodiment of the present invention, a laser welding system comprises a source for a laser beam, a collimator which is adapted to collimate the laser beam, and a focusing means which is adapted to focus the collimated laser beam onto a concentrated point on a workpiece to be welded, wherein an optical element is arranged between the collimator and the focusing means, the optical element being adapted to spread a power distribution of the laser beam along a first direction running at an angle to an axis of the collimated laser beam.

According to a preferred embodiment of the present invention, a bifocal element is arranged between the optical element and the collimator.

According to a preferred embodiment of the present invention, a bifocal element is arranged between the optical element and the focusing means.

According to one embodiment of the present invention, a laser welding system comprises a source for a laser beam, a collimator which is adapted to collimate the laser beam, and a focusing means which is adapted to focus the collimated laser beam onto a concentrated point on a workpiece to be welded, wherein an optical element is arranged between the source for the laser beam and the collimator, the optical element being adapted to spread a power distribution of the laser beam along a first direction running at an angle to an axis of the collimated laser beam.

According to a preferred embodiment of the present invention, the first direction runs substantially perpendicularly to the axis of the collimated laser beam. According to a preferred embodiment of the present invention, a bifocal element is arranged between the collimator and the focusing means.

According to a preferred embodiment of the present invention, the optical element is adapted to spread the power distribution of the laser beam onto at least two points on the workpiece to be welded, the at least two points being preferably arranged in series.

According to a preferred embodiment of the present invention, the optical element is adapted to spread the power distribution of the laser beam along at least one line on the workpiece to be welded.

According to a preferred embodiment of the present invention, the optical element is adapted to spread the power distribution of the laser beam along at least two lines on the workpiece to be welded, the at least two lines being arranged in series.

According to a preferred embodiment of the present invention, the optical element is adapted to spread the power distribution of the laser beam along the first direction and a second direction, the second direction running at an angle to the axis of the collimated laser beam and to the first direction.

According to a preferred embodiment of the present invention, the second direction runs substantially perpendicularly to the axis of the collimated laser beam and to the first direction.

According to a preferred embodiment of the present invention, the optical element is adapted to spread the power distribution of the laser beam in accordance with at least one of a cuboidal, rectangular, trapezoidal, oval-shaped or annular pattern on the workpiece to be welded.

According to a preferred embodiment of the present invention, the optical element is an arrangement of microlenses.

According to a preferred embodiment of the present invention, the optical element is a diffractive optical element.

According to one embodiment of the present invention, a method for welding by means of a laser beam includes the generating of a laser beam, the collimating of the laser beam by means of a collimator, and the focusing of the collimated laser beam by means of a focusing means onto a concentrated point on a workpiece to be welded, wherein the collimated laser beam is passed through an optical element between the collimator and the focusing means in order to spread a power distribution of the laser beam along a first direction running at an angle to an axis of the collimated laser beam.

According to one embodiment of the present invention, a method for welding by means of a laser beam includes the generating of a laser beam, the collimating of the laser beam by means of a collimator, and the focusing of the collimated laser beam by means of a focusing means onto a concentrated point on a workpiece to be welded, wherein the generated laser beam is passed through an optical element between the source for the laser beam and the collimator in order to spread a power distribution of the laser beam along a first direction running at an angle to an axis of the collimated laser beam.

The invention will be described hereinafter in greater detail based on the configurations illustrated in the appended drawings. Similar or corresponding details of the laser welding system according to the invention are provided with the same reference numerals in the figures, in which:

FIG. 1 shows a profile of a Gaussian power distribution of the laser beam;

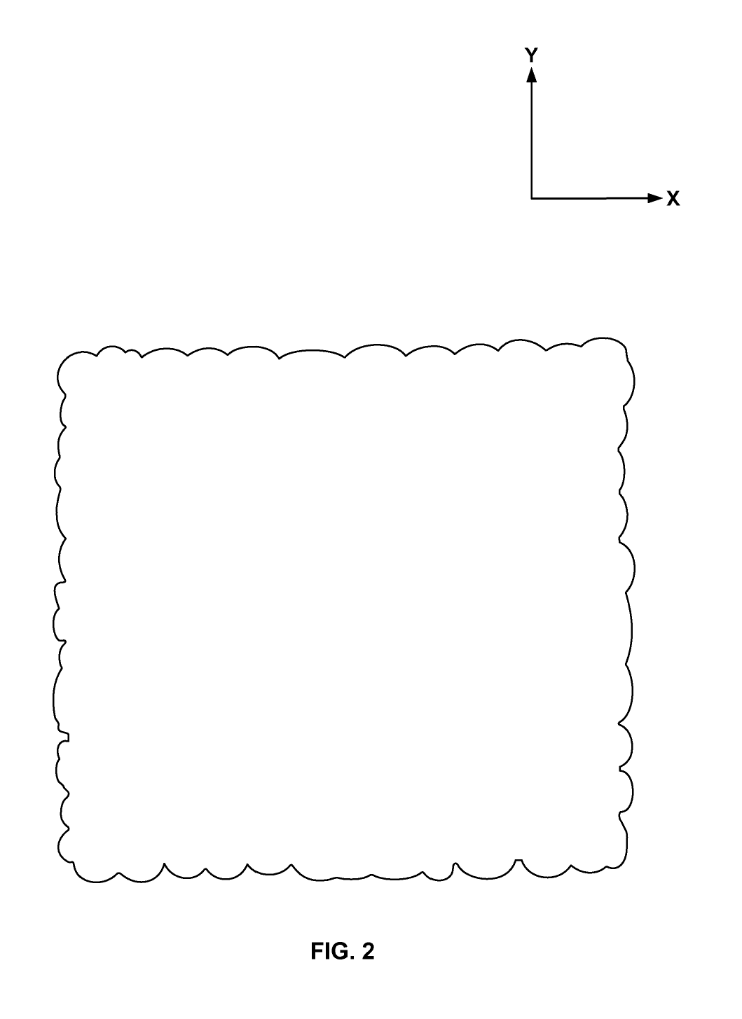

FIG. 2 shows a profile of the power distribution of a laser beam after it has passed through processing optics of a laser welding system according to one embodiment of the present invention;

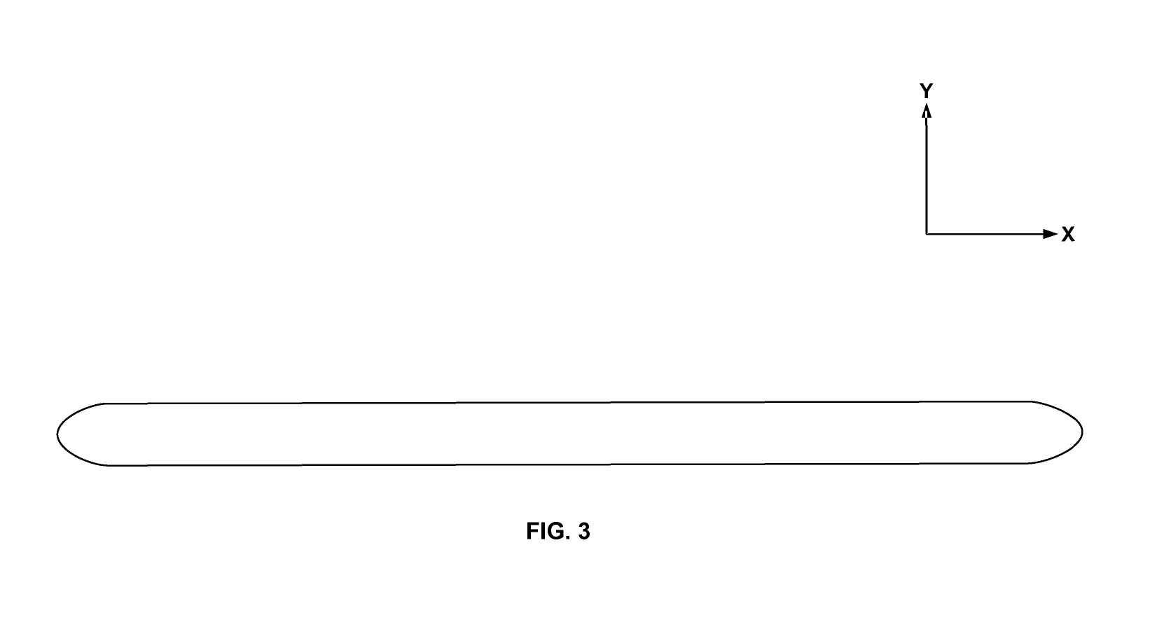

FIG. 3 shows a profile of the power distribution of a laser beam after it has passed through processing optics of a laser welding system according to a further embodiment of the present invention;

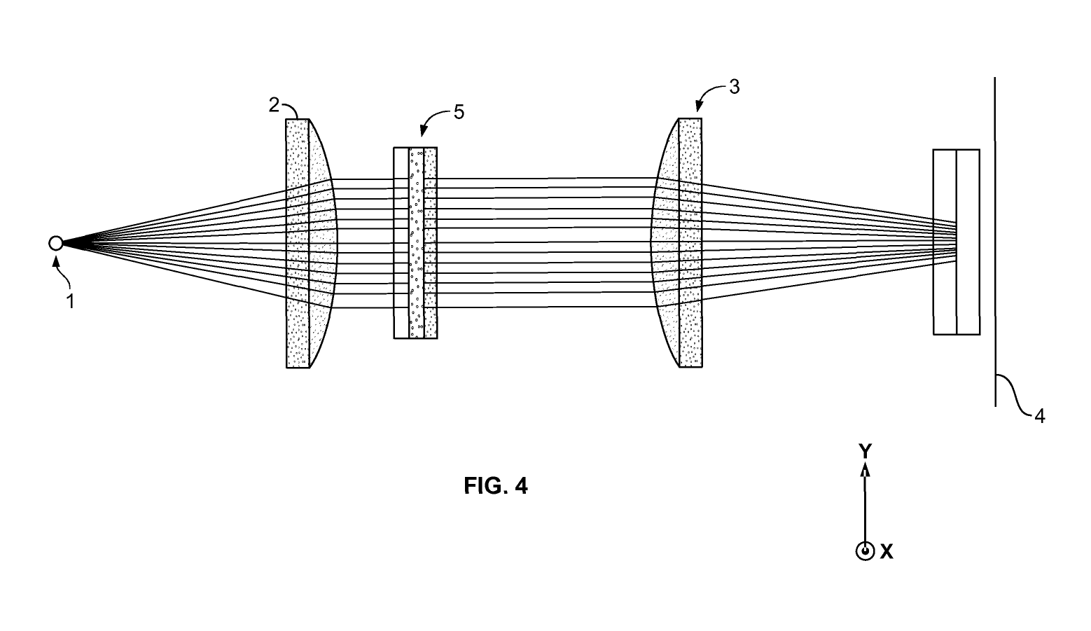

FIG. 4 is a schematic view of processing optics according to a first embodiment of a laser welding system according to the present invention;

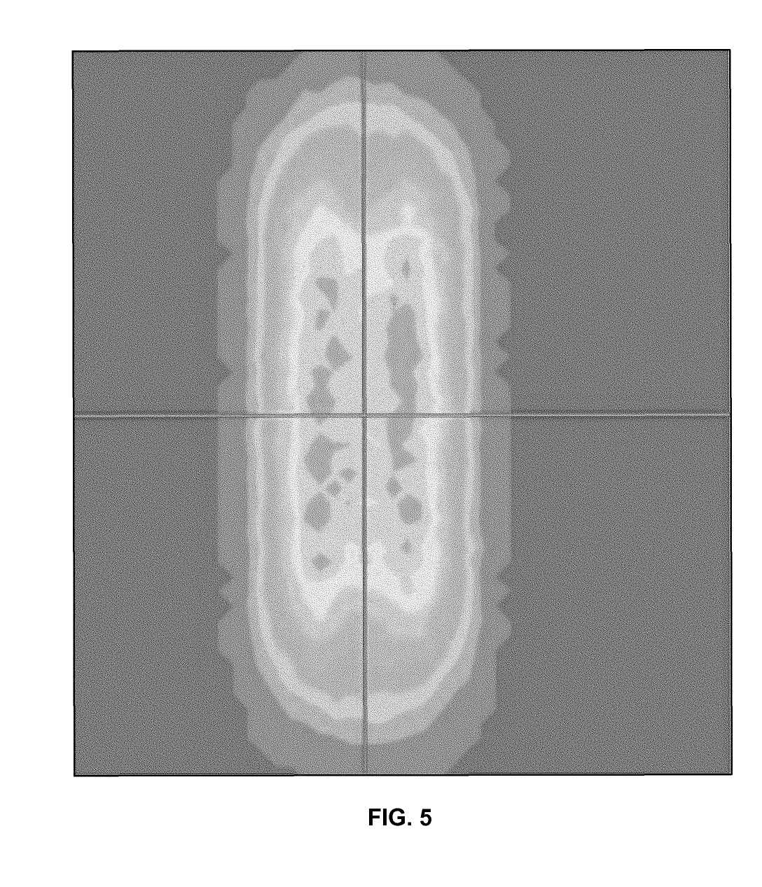

FIG. 5 shows a profile of the power distribution of the laser beam after it has passed through the processing optics shown in FIG. 4;

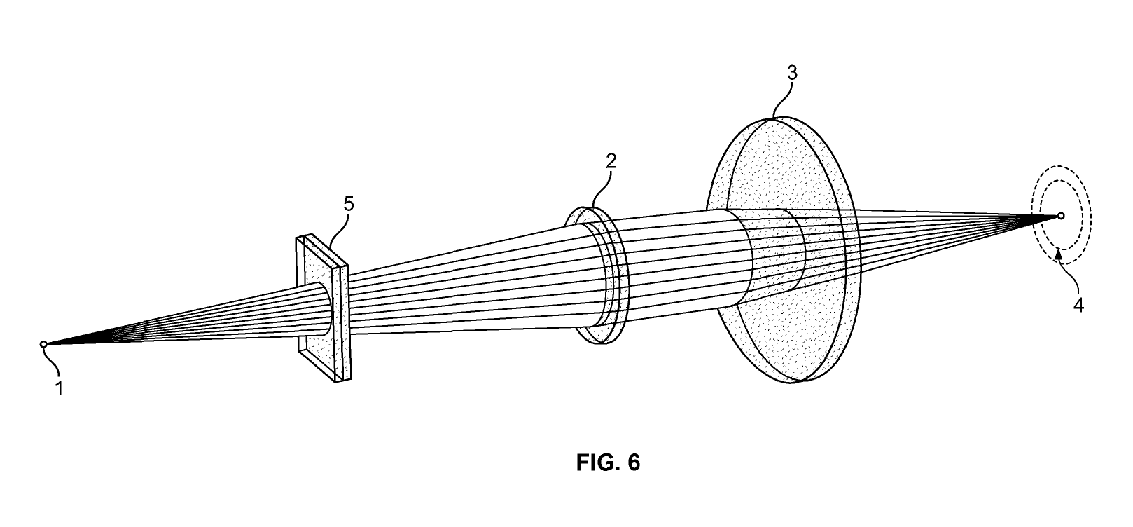

FIG. 6 is a schematic view of processing optics according to a second embodiment of a laser welding system according to the present invention;

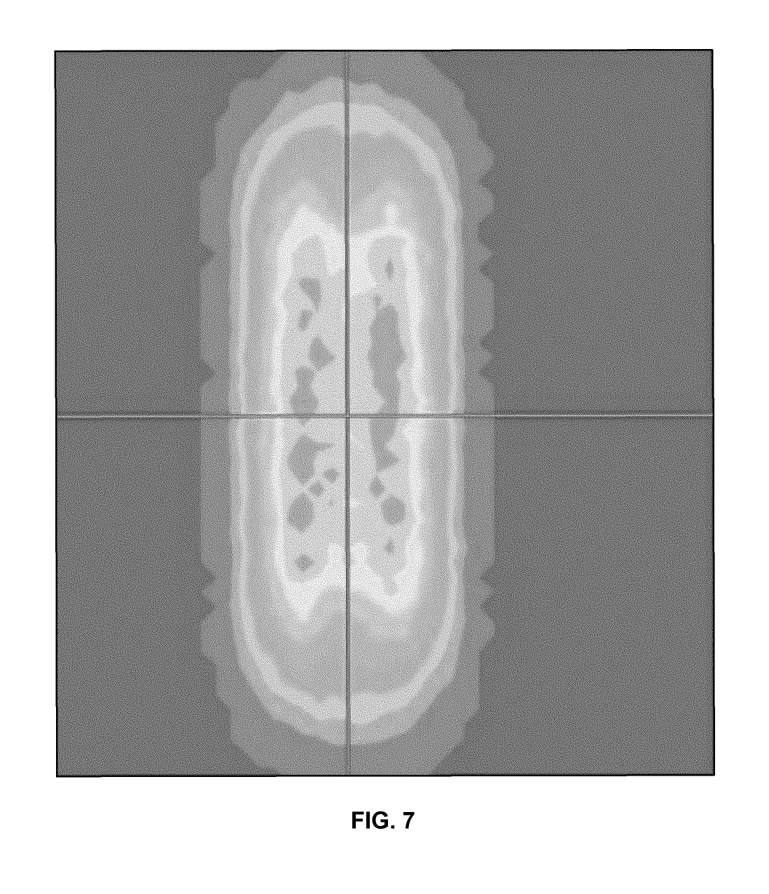

FIG. 7 shows a profile of the power distribution of the laser beam after it has passed through the processing optics shown in FIG. 6;

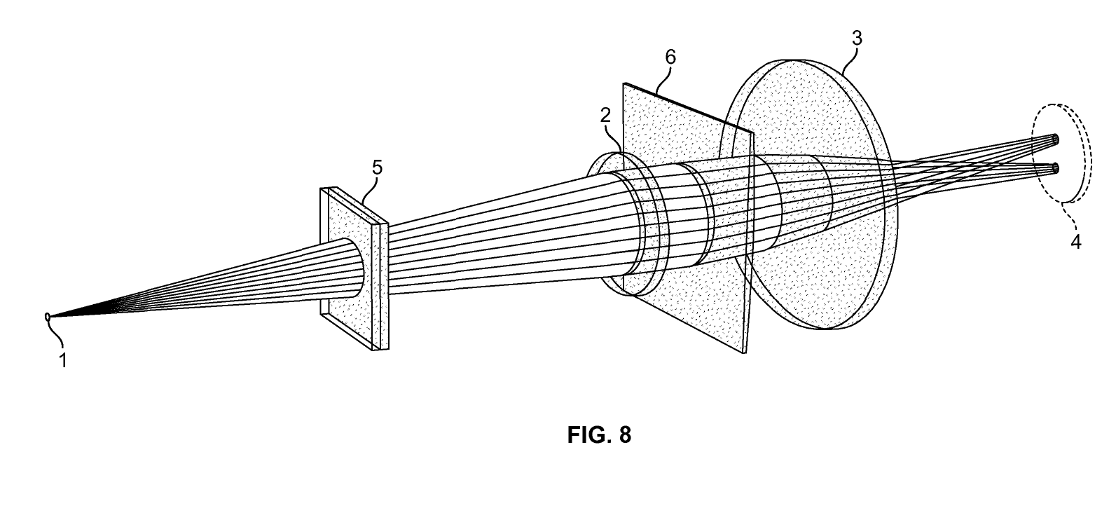

FIG. 8 is a schematic view of processing optics according to a third embodiment of a laser welding system according to the present invention; and

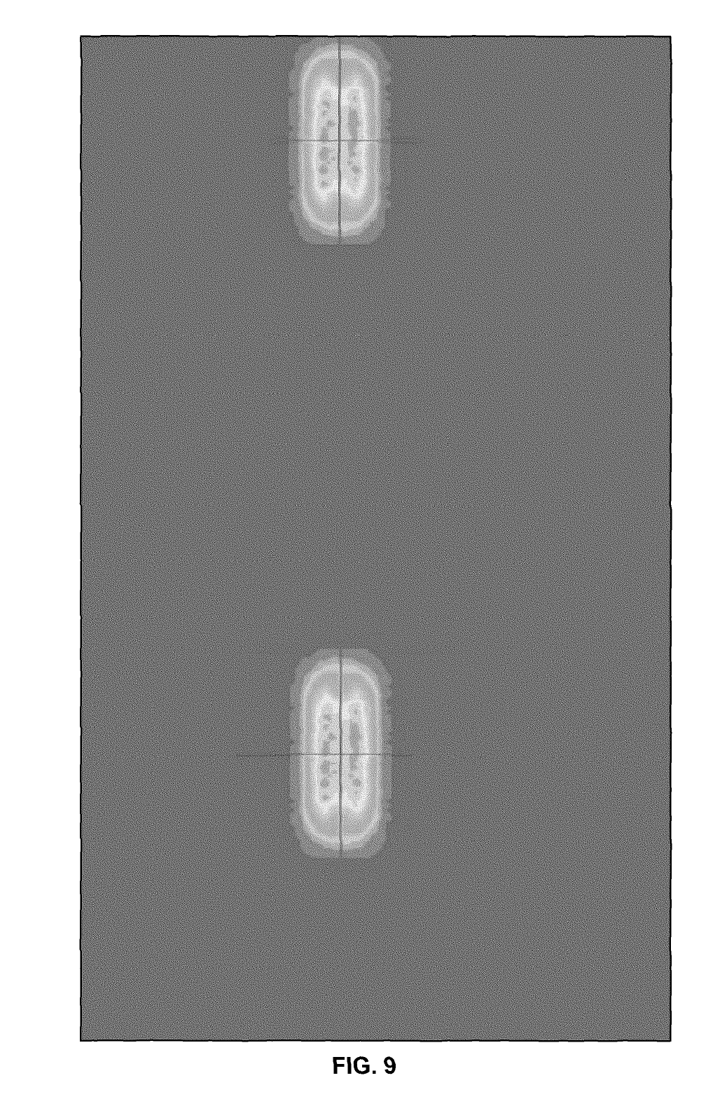

FIG. 9 shows a profile of the power distribution of the laser beam after it has passed through the processing optics shown in FIG. 8.

FIG. 2 shows a profile of the power distribution of a laser beam generated by processing optics of a laser welding system according to one embodiment of the present invention. Compared to the Gaussian power distribution shown in FIG. 1, it is apparent from FIG. 2 that the power distribution of the laser beam is more homogeneous, as the power is not only concentrated on a hot spot positioned at the centre, but is distributed over a larger area.

The power of the central part of the laser beam shown in FIG. 2 is less than the power of the corresponding part of the laser beam shown in FIG. 1. However, in return, the power of the part of the laser beam shown in FIG. 2 that is positioned at the edge of the laser beam is greater than the power of the corresponding part of the laser beam shown in FIG. 1. Thus, according to this embodiment of the present invention, the power distribution of the laser beam shown in FIG. 2 is spread along a first direction X running perpendicularly to the axis of the collimated laser beam.

Although FIG. 2 shows a spread of the power distribution of the laser beam along a first direction X running perpendicularly to the axis of the collimated laser beam, the present invention is not limited to an angle of 90° to the axis of the collimated laser beam, but rather the optical element is adapted to spread the power distribution of the laser beam along a first direction running at any desired angle to the axis of the collimated laser beam. This can be achieved in that the optical element is positioned at the corresponding angle to the axis of the collimated laser beam, for example by tilting the main plane of the optical element in relation to the axis of the collimated laser beam.

In addition, according to a preferred embodiment of the present invention, the power distribution of the laser beam shown in FIG. 2 is spread along a second direction Y running perpendicularly to the axis of the collimated laser beam and to the first direction X.

Although FIG. 2 shows a spread of the power distribution of the laser beam along a first direction X and a second direction Y, the first direction X and the second direction Y being perpendicular to the axis of the collimated laser beam and to each other, a case of this type is a preferred embodiment of the present invention. The present invention is not limited thereto; on the contrary, the power distribution of the laser beam is spread along a second direction running at any desired angle to the axis and to the first direction.

FIG. 3 shows another embodiment of the present invention, the power distribution of the laser beam being spread exclusively along the direction X. However, the power of the laser beam can equally be distributed along the direction Y, such as is illustrated in FIG. 7. The invention is not limited to a specific angle and the power of the laser beam can in fact be distributed at any desired angle.

According to one embodiment of the present invention, the optical element is adapted to spread the power distribution of the laser beam onto at least two points on the workpiece to be welded, the at least two points being arranged in series. The power distribution of the laser beam can also be spread along at least one line on the workpiece to be welded, such as may be seen in FIG. 3, for example. However, the power distribution of the laser beam can also be spread along two lines on the workpiece to be welded, the at least two lines being arranged in series.

The manner in which a homogeneous welding region of this type can be achieved by the present invention will be described hereinafter.

FIG. 4 is a schematic view of processing optics according to a first embodiment of a laser welding system according to the present invention. The processing optics comprise a source 1 for a laser beam, a collimator 2 which collimates the laser beam, a focusing means 3, for example a lens, which focuses the collimated laser beam onto a workpiece 4 to be welded.

An optical element 5, which allows the power distribution of the laser beam to be spread at least along a direction running at an angle to an axis of the collimated laser beam, is arranged between the collimator 2 and the focusing means 3.

In the embodiment of FIG. 4, the optical element 5 is arranged in such a way that its plane runs substantially parallel to the plane of the collimator 2 and of the focusing means 3. However, the optical element 5 can be tilted, so that its plane is arranged at an angle to the plane of the collimator 2 and of the focusing means 3. Thus, the power distribution of the laser beam can be spread along a direction running at any desired angle to the axis of the collimated laser beam.

According to a preferred embodiment of the present invention, the optical element 5 is an arrangement of micro lenses.

Microlenses are used wherever optical systems and measurements have to be size-reduced into the millimetre range. However, miniature lenses are also used in systems of optical data transmission, for example for the coupling of fibre optics or in the field of what are known as “flat” optics. In this case, instead of one large lens, a large number of small lenses are used next to one another and much shorter imaging distances are thus achieved. The original and image are thus much closer together. This allows the overall depth of optical apparatuses to be greatly reduced. These flat optical systems are currently already used in various types of scanners and copiers. The original documents are scanned with microlenses and transferred to the light-sensitive drum.

According to a further preferred embodiment of the present invention, the optical element 5 is a diffractive optical element instead of an arrangement of microlenses.

A diffractive optical element is a substrate on which a microstructure is plotted, allowing almost any desired diffractive effects to be generated. Specific microstructures are formed by a lithographic etching method. Diffractive optical elements are used to shape laser beams by diffraction on a grating or to break them down into a plurality of partial beams. Different materials can be used, such as for example ZnSe, ZnS or GaAs.

The optical element 5, which is arranged between the collimator 2 and the focusing means 3, allows the power distribution of the collimated laser beam to be spread along a first direction running at an angle to the axis of the collimated laser beam. FIG. 5 shows a spread of the power distribution perpendicularly to the axis of the collimated laser beam along the first direction Y.

However, according to one embodiment of the present invention, the power distribution of the laser beam can also be spread along a first direction and a second direction, the second direction running perpendicularly to the axis of the collimated laser beam and to the first direction. The power distribution of the laser beam can be spread in accordance with at least one of a cuboidal, rectangular, trapezoidal, oval-shaped or annular pattern on the workpiece to be spread. The corresponding pattern is implemented by the corresponding selection of the optical element.

FIG. 6 is a schematic view of processing optics according to a second embodiment of a laser welding system according to the present invention.

The processing optics comprise a source 1 for a laser beam, a collimator 2 which collimates the laser beam, a focusing means 3, for example a lens, which focuses the collimated laser beam onto a workpiece 4 to be welded.

In this embodiment, the optical element 5 is arranged between the source 1 for the laser beam and the collimator 2. FIG. 7 shows the spread of the power distribution along the first direction Y. However, the power distribution can also be spread at any desired angle.

FIG. 8 is a schematic view of processing optics according to a third embodiment of a laser welding system according to the present invention.

The processing optics comprises a source 1 for a laser beam, a collimator 2 which collimates the laser beam, a focusing means 3, for example a lens, which focuses the collimated laser beam onto a workpiece 4 to be welded.

In this embodiment, as in the second embodiment, the optical element 5 is arranged between the source 1 for the laser beam and the collimator 2. In addition, a bifocal element is arranged between the collimator 2 and the focusing means 3. FIG. 9 shows the spread of the power distribution of the two laser beams generated by the bifocal element along the first direction Y.

The present invention allows a homogeneous welding region to be achieved in that the power distribution is spread along a direction running at an angle to the axis of the collimated laser beam. This ensures a more advantageous energy input in the case of a poor position of the welding spot. The invention is particularly suitable for line welding during a stamping operation.

1-16. (canceled)

17. Laser welding system comprising:
a source for a laser beam;
a collimator which is adapted to collimate the laser beam; and
a focusing means which is adapted to focus the collimated laser beam onto a concentrated point on a workpiece to be welded,
wherein an optical element is arranged between the collimator and the focusing means, the optical element being adapted to spread a power distribution of the laser beam along a first direction running at an angle to an axis of the collimated laser beam.

18. Laser welding system according to claim 17, wherein a bifocal element is arranged between the optical element and the collimator.

19. Laser welding system according to claim 17, wherein a bifocal element is arranged between the optical element and the focusing means.

20. Laser welding system according to claim 17, wherein the first direction runs substantially perpendicularly to the axis of the collimated laser beam.

21. Laser welding system according to claim 17, wherein a bifocal element is arranged between the collimator and the focusing means.

22. Laser welding system according to claim 17, wherein the optical element is adapted to spread the power distribution of the laser beam onto at least two points on the workpiece to be welded, the at least two points being preferably arranged in series.

23. Laser welding system according to claim 17, wherein the optical element is adapted to spread the power distribution of the laser beam along at least one line on the workpiece to be welded.

24. Laser welding system according to claim 23, wherein the optical element is adapted to spread the power distribution of the laser beam along at least two lines on the workpiece to be welded, the at least two lines being preferably arranged in series.

25. Laser welding system according to claim 17, wherein the optical element is adapted to spread the power distribution of the laser beam along the first direction and a second direction, the second direction running at an angle to the axis of the collimated laser beam and to the first direction.

26. Laser welding system according to claim 25, wherein the second direction runs substantially perpendicularly to the axis of the collimated laser beam and to the first direction.

27. Laser welding system according to claim 17, wherein the optical element is adapted to spread the power distribution of the laser beam in accordance with at least one of a cuboidal, rectangular, trapezoidal, oval-shaped or annular pattern on the workpiece to be welded.

28. Laser welding system according to claim 17, wherein the optical element is an arrangement of microlenses.

29. Laser welding system according to claim 17, wherein the optical element is a diffractive optical element.

30. Laser welding system comprising:
a source for a laser beam,
a collimator which is adapted to collimate the laser beam, and
a focusing means which is adapted to focus the collimated laser beam onto a concentrated point on a workpiece to be welded,
wherein an optical element is arranged between the source for the laser beam and the collimator, the optical element being adapted to spread a power distribution of the laser beam along a first direction running at an angle to an axis of the collimated laser beam.

31. Method for welding by means of a laser beam, wherein the welding method includes the following steps:
generating a laser beam;
collimating the laser beam by means of a collimator; and
focusing the collimated laser beam by means of a focusing means onto a concentrated point on a workpiece to be welded,
wherein the collimated laser beam is passed through an optical element between the collimator and the focusing means in order to spread a power distribution of the laser beam along a first direction running at an angle to an axis of the collimated laser beam.

32. Method for welding by means of a laser beam, wherein the welding method includes the following steps:
generating a laser beam;
collimating the laser beam by means of a collimator; and
focusing the collimated laser beam by means of a focusing means onto a concentrated point on a workpiece to be welded,
wherein the generated laser beam is passed through an optical element between the source for the laser beam and the collimator in order to spread a power distribution of the laser beam along a first direction running at an angle to an axis of the collimated laser beam.
